(19) United States
(12) Patent Application Publication
(10) Pub. No.: US 2026/0017899 A1
(43) Pub. Date: Jan. 15, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: HIROKI WATABE, Tokyo (JP)

(21) Appl. No.: 19/264,297

(22) Filed: Jul. 9, 2025

(30) Foreign Application Priority Data
Jul. 12, 2024 (JP) 2024-112560

(51) Int. Cl. G06T 19/00; G06T 17/20

(52) U.S. Cl. CPC G06T 19/006; G06T 17/20

(57) ABSTRACT

An information processing apparatus one or more memories storing instructions, and one or more processors executing the instructions to function as an attribute setting unit configured to set, for a first virtual object permitted for shared display by a first user in a space where virtual objects are arranged, a display attribute indicating permission or denial of display in the space which is experienced by a second user based on an instruction issued by the second user, and a display control unit configured to control display of the first virtual object in the space experienced by the second user based on the display attribute set for the first virtual object.

### BACKGROUND

### Field of the Technology

The present disclosure relates to an information processing technique for performing shared display of a virtual object.

### Description of the Related Art

In recent years, a technique for utilizing mixed reality (hereinafter, referred to as “MR”) and displaying a virtual object arranged in a mixed reality space (hereinafter, referred to as “MR space”) in a shared manner among a plurality of users has been developed. By displaying the virtual object in a shared manner, all the users experiencing the MR space can have a common experience through the virtual object displayed in the shared manner, and smooth communication is enabled.

Japanese Patent Application Laid-Open No. 2012-168646 discusses a technique for enabling control to display a virtual object in a shared manner or not display the virtual object on terminals of other users experiencing an MR space by an owner user of the virtual object who sets a sharing permission or denial for the virtual object.

### SUMMARY

According to an aspect of the present disclosure, an information processing apparatus includes one or more memories storing instructions, and one or more processors executing the instructions to function as an attribute setting unit configured to set, for a first virtual object permitted for shared display by a first user in a space where virtual objects are arranged, a display attribute indicating permission or denial of display in the space which is experienced by a second user based on an instruction issued by the second user, and a display control unit configured to control display of the first virtual object in the space experienced by the second user based on the display attribute set for the first virtual object.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration example of a head-mounted display (HMD) system.

FIG. 2 is a diagram illustrating a configuration example of an HMD.

FIG. 3 is a diagram illustrating a configuration example of an information processing apparatus.

FIG. 4 is a diagram illustrating a functional configuration example of the information processing apparatus according to a first exemplary embodiment.

FIG. 5 is a flowchart illustrating information processing according to the first exemplary embodiment.

FIGS. 6A and 6B are diagrams each illustrating an example of a display attribute setting user interface (UI).

FIG. 7 is a flowchart illustrating virtual object display processing appropriate for a display attribute.

FIG. 8 is a diagram illustrating a functional configuration example of an information processing apparatus according to a second exemplary embodiment.

FIGS. 9A, 9B, and 9C are explanatory diagrams illustrating an example of overlap of virtual objects.

FIG. 10 is a flowchart illustrating information processing according to the second exemplary embodiment.

FIG. 11 is a flowchart illustrating overlap determination processing.

FIG. 12 is a diagram illustrating a functional configuration example of an information processing apparatus according to a third exemplary embodiment.

FIG. 13 is a flowchart illustrating information processing according to the third exemplary embodiment.

FIG. 14 is a flowchart illustrating blocking determination processing.

FIG. 15 is a diagram illustrating a functional configuration example of an information processing apparatus according to a fourth exemplary embodiment.

FIG. 16 is an explanatory diagram illustrating a display example of a viewing region.

FIG. 17 is a flowchart illustrating information processing according to the fourth exemplary embodiment.

FIG. 18 is an explanatory diagram of a region where a virtual plane and a viewing region overlap.

FIG. 19 is a flowchart illustrating viewing region setting processing.

FIG. 20 is an explanatory diagram of denial control of shared display that is based on a non-display region.

### DESCRIPTION OF THE EMBODIMENTS

For example, in a case where a user wishes to arrange a virtual object at a location where a different virtual object is displayed in a shared manner, the user needs to issue a request for changing a shared display setting to denied, to an owner user of the virtual object displayed in a shared manner.

Such a request is a burdensome and troublesome task for both of the users who are experiencing mixed reality (MR).

In view of the foregoing, the present disclosure is directed to enabling a reduction of the time and effort of the user.

Hereinafter, exemplary embodiments of the present disclosure will be described with reference to the drawings. The following exemplary embodiments are not intended to limit the present disclosure. In addition, not all combinations of features described in the present exemplary embodiment are always essential to the solution of the present disclosure. The configuration of the exemplary embodiment can be appropriately modified or changed depending on the specification of an apparatus to which the present disclosure is applied and various conditions (use conditions, usage environment, etc.). In addition, exemplary embodiments to be described below and modified examples may be partially combined as appropriate. In the following exemplary embodiments, redundant descriptions of identical hardware configurations, functional configurations, and processing processes (processing steps) are omitted.

In the exemplary embodiments to be described below, an information processing system (HMD system) in which a head-mounted display (hereinafter, referred to as an HMD) to be used by each user and an information processing apparatus are connected will be described as an example. The HMD system in each of the following exemplary embodiments is a system capable of providing an MR experience through a mixed reality space (MR space) to two or more users wearing HMDs.

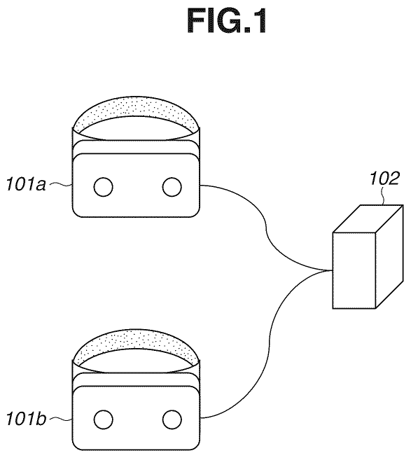

FIG. 1 is a diagram illustrating a configuration example of an HMD system in which a plurality of HMDs is connected to an information processing apparatus, as an application example of an exemplary embodiment. FIG. 1 illustrates an example case where two HMDs that are an HMD 101a and an HMD 101b exist as the plurality of

HMDs, and these HMDs 101a and 101b are connected with an information processing apparatus 102. The HMD 101a is an HMD that a certain user wears on his/her head, and the HMD 101b is an HMD that another user different from the user who wears the HMD 101a wears on his/her head. An input device (not illustrated) such as a controller or a keyboard for receiving input from each of the users is also connected to the information processing apparatus 102.

The HMD 101a and the information processing apparatus 102, and the HMD 101b and the information processing apparatus 102 are connected via a video signal line such as a high-definition multimedia interface (HDMI)® cable, or a data signal line such as a universal serial bus (USB) cable, and communication of image data and control signals is performed. The connection between each HMD and the information processing apparatus 102 may be wireless connection via a wireless local area network (LAN). The connection between the information processing apparatus 102 and an input device (not illustrated) is wired connection via a USB cable, or wireless connection via Bluetooth®. Furthermore, the information processing apparatus 102 may exist for each HMD, namely the HMD 101a and the HMD 101b. In this case, information processing apparatuses existing for the respective HMDs are connected via a network cable or the like, and exchange information. Alternatively, as another example in which the information processing apparatuses exist for the respective HMDs, namely the HMD 101a and the HMD 101b, a configuration of an integrated HMD system in which the HMD 101a includes an information processing apparatus thereinside, and the HMD 101b similarly includes an information processing apparatus thereinside may be employed. Furthermore, as yet another example, a configuration in which an information processing apparatus is included in one of the HMD 101a and the HMD 101b may be employed.

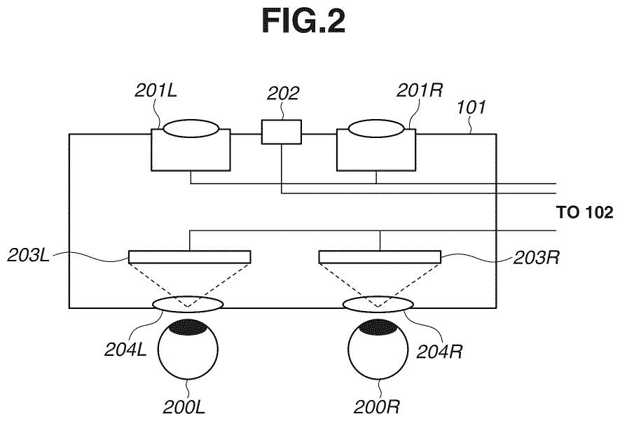

In the following description, in a case where there is no need to make a distinction between the HMD 101a and the HMD 101b, these will be collectively referred to as the HMD 101 with the alphabetical suffixes of the reference numerals being omitted. The same applies to an internal hardware configuration of the HMD 101, which will be described below with reference to FIG. 2. In the following description, image data to be handled in each HMD and the information processing apparatus 102 will be simply referred to as an image unless otherwise clear indication is specifically required.

FIG. 2 is a diagram illustrating an example of an internal hardware configuration of the HMD 101.

To implement position tracking of an HMD, the HMD 101 includes a plurality of RGB cameras 201, and an inertial measurement unit (IMU) (not illustrated) such as a gyro sensor or an acceleration sensor. FIG. 2 illustrates an example in which two RGB cameras 201L and 201R are provided as the plurality of RGB cameras 201. Furthermore, the HMD 101 also includes a distance sensor 202 such as a light detection and ranging (LiDAR) sensor for acquiring depth information in a depth direction.

The HMD 101 also includes a left eye display 203L and a right eye display 203R, each including a display panel such as a liquid crystal panel or an organic electroluminescence (EL) panel, for displaying images respectively corresponding to a left eye 200L and a right eye 200R of the user. Furthermore, the HMD 101 includes a left eye eyepiece lens 204L arranged at a position corresponding to the left eye 200L of the user, and a right eye eyepiece lens 204R arranged at a position corresponding to the left eye 200L of the user. With this configuration, the user views an enlarged virtual image of a left eye display image displayed on the display 203L, through the eyepiece lens 204L, and views an enlarged virtual image of a right eye display image displayed on the display 203R, through the eyepiece lens 204R. At this time, by providing parallax as appropriate between the left eye display image to be displayed on the left eye display 203L and the right eye display image to be displayed on the right eye display 203R, it is possible to provide the user with video perception with a sense of depth.

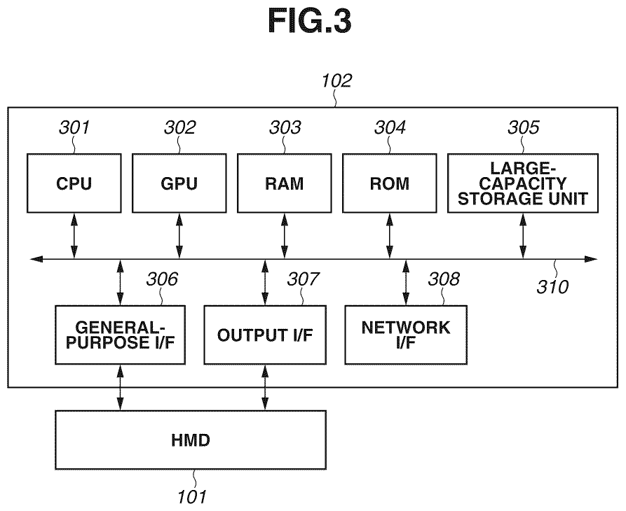

FIG. 3 is a diagram illustrating an example of a hardware configuration of the information processing apparatus 102.

A central processing unit (CPU) 301 is a processor that controls each component in the information processing apparatus 102, and executes various types of calculation processing. Upon receiving a command from the CPU 301, a graphics processing unit (GPU) 302 generates a display image to be displayed on the display 203, by performing rendering of a virtual object and superimposing the virtual object on a real image acquired by the RGB camera 201 of the HMD 101.

A random access memory (RAM) 303 functions as a main memory, a work area, and the like of the CPU 301. A read-only memory (ROM) 304 stores programs to be executed by the CPU 301. A large-capacity storage unit 305 stores an information processing program according to the present exemplary embodiment that is to be executed by the CPU 301, and various types of data to be used in information processing described below. As the large-capacity storage unit 305, for example, a hard disc drive (HDD) or a solid state drive (SSD) is assumed. A general-purpose interface (I/F) 306 is a serial bus interface for a USB or Institute of Electrical and Electronics Engineers (IEEE) 1394, and is connected with the IMU and the distance sensor 202 included in the HMD 101. With this configuration, the information processing apparatus 102 can acquire position and orientation information and a depth image to a target object from the HMD 101. Further, the general-purpose I/F 306 is used to acquire real images of the RGB camera 201 of the HMD 101. An output I/F 307 is an interface for an HDMI or display port, and is used to display a display image on the display 203 of the HMD 101. A network I/F 308 performs communication via a network such as a LAN or the Internet under the control of the CPU 301. A system bus 310 controls a data flow in the apparatus. The information processing apparatus 102 includes components other than these, but the description of these components will be omitted.

Hereinafter, a functional configuration of the information processing apparatus 102 according to a first exemplary embodiment will be described.

The information processing apparatus 102 according to the present exemplary embodiment is an apparatus that executes information processing of arranging one or more virtual objects in an MR space and displaying the virtual objects on the displays 203 of the respective HMDs 101 worn by the plurality of users. In addition, the information processing apparatus 102 according to the present exemplary embodiment can also execute information processing in which a user who is experiencing MR arranges a virtual object in the MR space, and the virtual object is moved, deleted, or the like in the MR space in response to an instruction from the user. Furthermore, the information processing apparatus 102 according to the present exemplary embodiment can also execute information processing for setting shared display of virtual objects to “permitted” or “denied” in response to input from the user.

In the description of the present exemplary embodiment, an HMD to be used by a first user of the plurality of users who is experiencing MR using the HMD system will be referred to as a first HMD 101, and a virtual object set by the first user will be referred to as a first virtual object. In the present exemplary embodiment, another user different from the first user will be referred to as a second user, an HMD to be used by the second user will be referred to as a second HMD 101, and a virtual object set by the second user will be referred to as a second virtual object. In the present exemplary embodiment, an example in which two users who are experiencing MR correspond to the first user and the second user will be described, but the number of users may be three or more. In addition, the number of first users and the number of second users in the present exemplary embodiment are not limited to one, and the number of first users may be two or more, and the number of second users may be two or more as well. Furthermore, the number of first virtual objects to be set by the first user is not limited to one, and may be two or more. Similarly, the number of second virtual objects to be set by the second user is not limited to one, and may be two or more. In a case where a plurality of first virtual objects is set by the first user, the first user can move or delete each first virtual object in the MR space and set the shared display to permitted or denied for each first virtual object. Similarly, in a case where a plurality of second virtual objects is set by the second user, the second user can move or delete each second virtual object in the MR space and set the shared display to permitted or denied for each second virtual object. In the present exemplary embodiment, in an MR space experienced by the first user and the second user, positions in the MR space are represented by the same coordinate system.

In the following exemplary embodiments, as an example, a case is described where the first user is a user who has set the shared display to permitted or denied for a virtual object.

The information processing apparatus 102 according to the present exemplary embodiment determines whether to display the first virtual object set by the first user on the second HMD 101 worn by the second user, based on the setting of permitting or denying shared display that is made by the first user. For example, in a case where the shared display of the first virtual object is set to “permitted” by the first user, the information processing apparatus 102 displays the first virtual object in an MR space of the second HMD 101. On the other hand, in a case where the shared display of the first virtual object is set to “denied” by the first user, the information processing apparatus 102 does not display the first virtual object in the MR space of the second HMD 101.

Furthermore, in the case where the shared display of the first virtual object is permitted by the first user, the information processing apparatus 102 according to the present exemplary embodiment determines whether to display the first virtual object on the second HMD 101, based on the setting of permitting or denying display that is made by the second user. More specifically, the information processing apparatus 102 according to the present exemplary embodiment controls the display of the first virtual object permitted for shared display by the first user, on the second HMD 101 based on a display attribute of permitting or denying display that is set by the second user. For example, in a case where the shared display of the first virtual object is permitted by the first user, if the display attribute of permitting the display of the first virtual object is set by the second user, the information processing apparatus 102 displays the first virtual object in the MR space of the second HMD 101. On the other hand, even if the shared display of the first virtual object is permitted, in a case where the display attribute of not permitting the display of the first virtual object is set by the second user, the information processing apparatus 102 performs control not to display the first virtual object in the MR space of the second HMD 101. In this manner, in the present exemplary embodiment, the second user can freely set whether to display or not display the first virtual object permitted for shared display by the first user, on the second HMD 101.

As described above, the information processing apparatus 102 performs the display control of a virtual object based on the setting of permitting/denying shared display of a virtual object, and the setting of the display attribute of permitting/denying display of a virtual object permitted for shared display. Because the display control of a virtual object that is based only on the setting of permitting/denying of shared display of a virtual object is substantially similar to an existing technique, the description thereof will be omitted. In the present exemplary embodiment, an example in which shared display of the first virtual object is permitted by the first user, and the second user sets the display attribute of permitting/denying display of the first virtual object will be described. Hereinafter, the second user sets the display attribute of permitting/denying display of the first virtual object permitted for shared display by the first user, and the information processing apparatus 102 performs display control of whether to display the first virtual object on the second HMD 101 based on the display attribute.

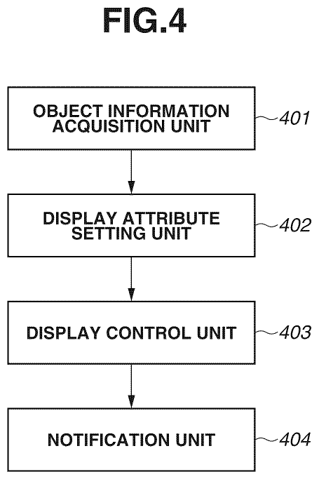

FIG. 4 is a diagram illustrating a functional configuration example of the information processing apparatus 102 according to the first exemplary embodiment that performs the above-described display control.

An object information acquisition unit 401 acquires information regarding a first virtual object permitted for shared display by the first user as described above, and information regarding a second virtual object set by the second user. Details of these pieces of information regarding the first virtual object and the second virtual object will be described below. Hereinafter, these pieces of information regarding the virtual objects will be referred to as virtual object information. A display attribute setting unit 402 acquires the display attribute of permitting or not permitting display of a first virtual object permitted for shared display by the first user, in the MR space of the second HMD 101 that is set by the second user.

A display control unit 403 performs the display control of displaying the second virtual object set by the second user in the MR space of the second HMD 101. When displaying the first virtual object permitted for shared display by the first user in the MR space of the second HMD 101, the display control unit 403 performs the display control based on the display attribute of permitting or denying display that is set by the second user for the first virtual object.

In a case where denial of display (refusal of display) of the first virtual object is set by the display attribute setting unit 402, a notification unit 404 generates notification information indicating the denial of display, and notifies the first HMD 101 being used by the first user who has set the first virtual object.

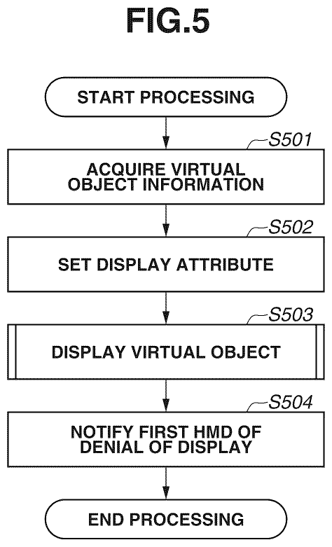

FIG. 5 is a flowchart illustrating a flow of information processing performed by each functional unit illustrated in FIG. 4, in the information processing apparatus 102 according to the present exemplary embodiment.

First, as processing in step S501, the object information acquisition unit 401 acquires virtual object information of a first virtual object permitted for shared display by the first user, and virtual object information of a second virtual object set by the second user. The virtual object information includes identification information about an HMD used by a user who has set a virtual object, a sharing setting flag indicating permission or denial of shared display, the position and orientation of the virtual object in the MR space, mesh data indicating the shape of the virtual object, and texture data indicating a pattern or the like.

Next, as processing in step S502, the display attribute setting unit 402 acquires a display attribute in which permission or denial of display of the first virtual object that has been permitted for shared display by the first user in the MR space of the second HMD 101 is set by the second user.

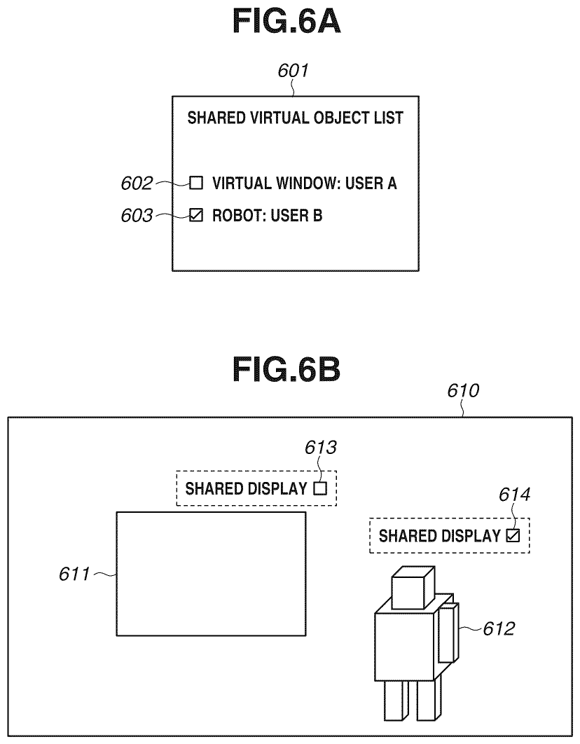

In the present exemplary embodiment, the setting of the display attribute for permitting or denying display of a virtual object permitted for shared display is performed by a user inputting an instruction via a graphical user interface (GUI), for example. FIGS. 6A and 6B are diagrams each illustrating an example of a GUI displayed when the user sets the display attribute. In the case of the present exemplary embodiment, these GUIs are displayed on a display screen of the second HMD 101 or a screen of the information processing apparatus 102 when the second user sets the display attribute.

FIG. 6A is a diagram illustrating an example of a GUI 601 including a list of first virtual objects permitted for shared display by the first user, and checkboxes respectively corresponding to these first virtual objects. FIG. 6A illustrates an example in a case where two users, namely users A and B, are first users, a virtual window exists as a virtual object set by the user A and permitted for shared display by the user A, and a robot exists as a virtual object set by the user B and permitted for shared display by the user B. On the GUI 601, checkboxes 602 and 603 respectively corresponding to the virtual objects permitted for shared display are provided. The information processing apparatus 102 according to the present exemplary embodiment sets a display attribute flag indicating that display is permitted by the second user to a virtual object corresponding to a checkbox checked by the second user. On the other hand, the information processing apparatus 102 sets a display attribute flag indicating that display is denied by the second user to a virtual object corresponding to a checkbox not checked by the second user.

FIG. 6B is a diagram illustrating an example of a GUI 610 in which first virtual objects permitted for shared display by the first user are arranged in an MR space, and near each first virtual object, a text and a checkbox for setting a display attribute are arranged. In the example in FIG. 6B, as in the example in FIG. 6A, two users, namely the users A and B, are the first users. In the example of the GUI 610 in FIG. 6B, a virtual window 611 set by the user A and permitted for shared display by the user A, and a virtual robot 612 set by the user B and permitted for shared display by the user B are arranged in the MR space.

Furthermore, in FIG. 6B, a checkbox 613 is arranged near the virtual window 611, and a checkbox 614 is arranged near the virtual robot 612. In the case of the example of the GUI 610 in FIG. 6B as well, the information processing apparatus 102 sets a display attribute flag indicating that display is permitted by the second user to a virtual object corresponding to a checkbox checked by the second user. Similarly, the information processing apparatus 102 sets a display attribute flag indicating that display is denied by the second user to a virtual object corresponding to a checkbox not checked by the second user. A method for setting the display attribute is not limited to the method that uses the GUIs exemplified in FIGS. 6A and 6B.

The description will return to the flowchart in FIG. 5.

Next, as processing in step S503, the display control unit 403 performs display control of displaying the second virtual object set by the second user in the MR space of the second HMD 101 as described above. In addition, the display control unit 403 controls whether to display the first virtual object permitted for shared display by the first user in the MR space of the second HMD 101 based on the display attribute flag of permission/denial that is set by the second user. Details of display control performed by the display control unit 403 in step S503 will be described below.

Then, as processing in step S504, in a case where the display attribute denying display (refusing display) of the first virtual object is set by the second user, the notification unit 404 notifies the first HMD 101 of the first user, who has set the first virtual object, of notification information indicating the denial. In a case where the display attribute of permitting display of the first virtual object is set by the second user, the notification unit 404 may notify the first HMD 101 of the first user of notification information indicating the permission, but as a matter of course, the notification unit 404 may omit the notification.

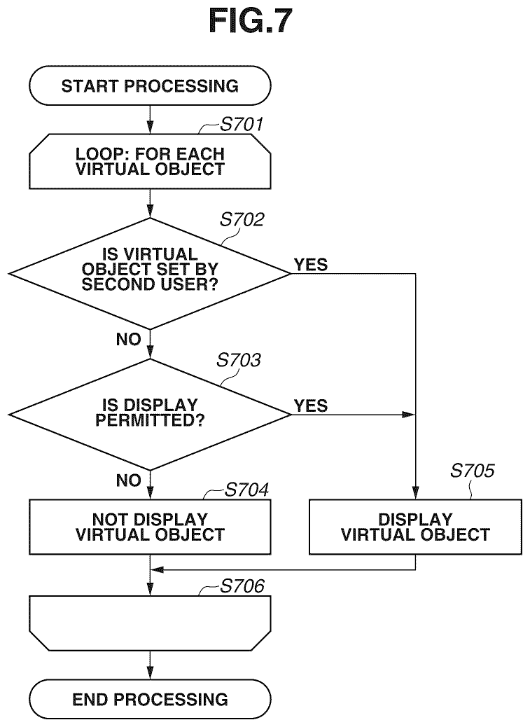

FIG. 7 is a flowchart illustrating the details of display control performed by the display control unit 403 in step S503.

In step S503, the display control unit 403 executes processing in steps S701 to S706 of FIG. 7 for all virtual objects existing in the MR space of the second HMD 101, which is used by the second user. In other words, the processing in steps S701 to S706 is repeatedly executed for each of the virtual objects.

In the repeated processing in steps S701 to S706, first, as processing in step S702, the display control unit 403 determines whether a virtual object that is a target of the repeated processing is a virtual object set by the second user. In the case of the present exemplary embodiment, the display control unit 403 determines whether a corresponding virtual object is the second virtual object set by the second user based on identification information of an HMD that is included in the virtual object information, for example. Then, in a case where it is determined in step S702 that the corresponding virtual object is the second virtual object set by the second user (YES in step S702), the processing of the display control unit 403 proceeds to step S705. On the other hand, in a case where it is determined that the corresponding virtual object is not the second virtual object set by the second user (NO in step S702), i.e., in a case where the corresponding virtual object is the first virtual object set by the first user, the processing of the display control unit 403 proceeds to step S703.

In a case where the processing proceeds to step S703, the display control unit 403 determines whether the display attribute of permitting display of the first virtual object set by the first user in the MR space of the second HMD 101 is set by the second user. In the case of the present exemplary embodiment, the display control unit 403 makes the determination based on whether a display attribute flag indicating that the second user has permitted display is set for the first virtual object. Then, in a case where it is determined in step S703 that the first virtual object is a first virtual object permitted for display by the second user (YES in step S703), the processing of the display control unit 403 proceeds to step S705. On the other hand, in a case where it is determined that the first virtual object is not a first virtual object permitted for display by the second user (NO in step S703), the processing of the display control unit 403 proceeds to step S704.

In a case where the processing proceeds to step S705, the display control unit 403 displays the virtual object in the MR space of the second HMD 101, which is used by the second user. More specifically, in this case, the display control unit 403 displays the virtual object generated based on the position and orientation of the virtual object in the MR space, mesh data indicating the shape of the virtual object, and texture data indicating a pattern or the like that are included in the virtual object information, in the MR space of the second HMD 101.

On the other hand, in a case where the processing proceeds to step S704, the display control unit 403 does not display the virtual object in the MR space of the second HMD 101, which is used by the second user.

After step S704 or S705, the processing of the display control unit 403 returns to step S702, and the display control unit 403 performs the processing in step S702 and subsequent steps on a next virtual object that is the processing target.

As described above, with the information processing apparatus 102 according to the first exemplary embodiment, the second user can freely set whether to display the first virtual object permitted for shared display by the first user in the MR space of the second HMD 101. In other words, in the case of the present exemplary embodiment, in a case where the second user wishes to arrange the second virtual object at a position of the first virtual object permitted for shared display by the first user, the second user need not issue a request for denying shared display of the first virtual object to the first user. With this configuration, according to the present exemplary embodiment, the time and effort of the burdensome and troublesome task for both of the users who are experiencing MR is reduced, and MR experience of both of the users is not disturbed.

In the above-described first exemplary embodiment, in a case where the first virtual object permitted for shared display by the first user is not desired to be displayed in the MR space of the second HMD 101, the second user can set the display of the first virtual object to “denied”.

In contrast to this, in a second exemplary embodiment, an example in which an information processing apparatus 102 automatically sets whether to display a first virtual object permitted for shared display by a first user in an MR space of a second HMD 101 used by a second user will be described.

Here, as a situation where the second user considers that the second user does not want to display the first virtual object permitted for shared display in the MR space of the second HMD 101, the following situation is assumed. For example, a case where the second user has already arranged a second virtual object at a position where the first virtual object is to be displayed, or a case where the second user wants to newly arrange the second virtual object at a position where the first virtual object is already displayed is assumed. In other words, in a case where the second virtual object set by the second user and the first virtual object permitted for shared display by the first user are at overlapping positions in the MR space of the second HMD 101, the second user considers that the second user does not want to display the first virtual object.

In view of the foregoing, the information processing apparatus 102 according to the second exemplary embodiment performs an overlap determination of determining whether the first virtual object permitted for shared display by the first user and the second virtual object set by the second user overlap in the MR space of the second HMD 101. Then, the information processing apparatus 102 according to the second exemplary embodiment automatically sets display of the first virtual object permitted for shared display by the first user, in the MR space of the second HMD 101 of the second user to permission or denial based on a result of the overlap determination. In the second exemplary embodiment, overlap of virtual objects includes not only a case where these virtual objects completely overlap, but also a case where the virtual objects overlap at least partially. More specifically, the overlap of virtual objects refers to a situation where, when the virtual objects are to be arranged in the MR space, the virtual objects contact each other or interfere with each other. In the second exemplary embodiment, the configuration of the HMD system is similar to that in the example illustrated in FIG. 1, and the configuration of the HMD 101 and the configuration of the information processing apparatus 102 are also similar to those in the examples illustrated in FIGS. 2 and 3, respectively. Thus, the illustration and description thereof will be omitted. Hereinafter, configurations and processing different from those in the first exemplary embodiment will be described.

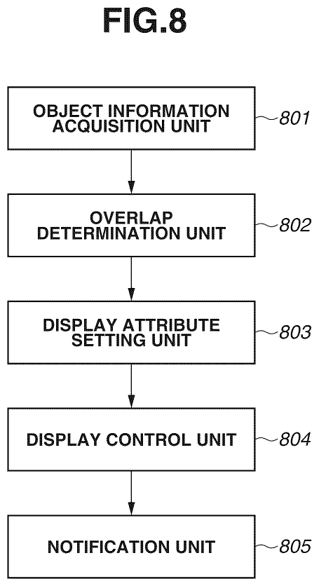

FIG. 8 is a diagram illustrating a functional configuration example of the information processing apparatus 102 according to the second exemplary embodiment. In the functional configuration illustrated in FIG. 8, an object information acquisition unit 801, a display control unit 804, and a notification unit 805 are substantially similar to the object information acquisition unit 401, the display control unit 403, and the notification unit 404, which are corresponding components in FIG. 4. Thus, the description thereof will be omitted.

In the information processing apparatus 102 according to the second exemplary embodiment, an overlap determination unit 802 performs an overlap determination of the second virtual object set by the second user and the first virtual object permitted for shared display by the first user.

A display attribute setting unit 803 sets a display attribute of permitting or denying display of the first virtual object in the MR space of the second HMD 101 based on an overlap determination result obtained by the overlap determination unit 802.

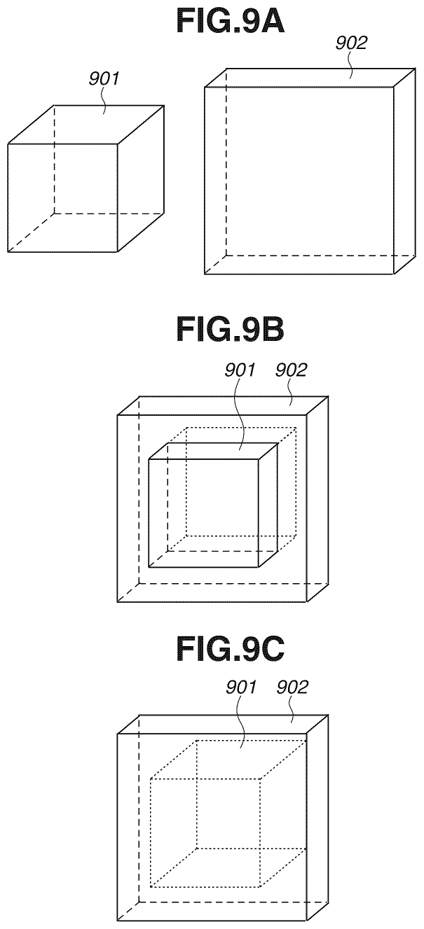

FIGS. 9A to 9C are diagrams illustrating an example of overlap of virtual objects.

FIG. 9A illustrates a first virtual object 901 set by the first user and permitted for shared display by the first user, and a second virtual object 902 set by the second user.

FIG. 9B illustrates an example in which the first virtual object 901 and the second virtual object 902 are arranged in the MR space based on pieces of information regarding positions and orientations that are included in their respective pieces of virtual object information. In other words, it is assumed that, when the first virtual object 901 and the second virtual object 902 are arranged in the MR space based on the pieces of information regarding positions and orientations that are included in their respective pieces of virtual object information, these virtual objects overlap.

In a case where the first virtual object 901 and the second virtual object 902 overlap in the MR space in this manner, the display attribute setting unit 803 according to the second exemplary embodiment sets a display attribute of the first virtual object 901 to “denied” so as not to display the first virtual object 901 in the MR space of the second HMD 101.

FIG. 9C illustrates an example in which the first virtual object 901 is controlled to be not displayed and only the second virtual object 902 is displayed by the display attribute of the first virtual object 901 being set to “denied”.

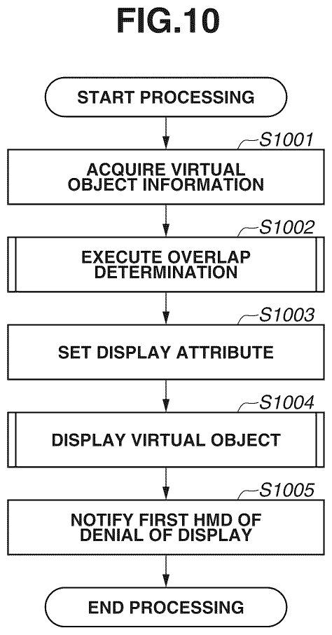

FIG. 10 is a flowchart illustrating a flow of information processing performed by each functional unit illustrated in FIG. 8, in the information processing apparatus 102 according to the second exemplary embodiment. In the flowchart in FIG. 10, because the processing in steps S1001, S1004, and S1005 is substantially similar to the processing in corresponding steps S501, S503, and S504 of FIG. 5, the description thereof will be omitted.

In the case of the second exemplary embodiment, after acquisition of virtual object information in step S1001, the processing of the information processing apparatus 102 proceeds to step S1002 in which processing is performed by the overlap determination unit 802. When the processing proceeds to step S1002, the overlap determination unit 802 executes an overlap determination of a second virtual object set by the second user and a first virtual object permitted for shared display by the first user. Details of overlap determination processing in step S1002 will be described below.

Next, in step S1003, the display attribute setting unit 803 sets a display attribute of permitting or denying display of the first virtual object in the MR space of the second HMD 101 based on a result of overlap determination obtained by the overlap determination unit 802. In a case where the first virtual object and the second virtual object overlap, the display attribute setting unit 803 sets a display attribute of the first virtual object to “denied”. On the other hand, in a case where the first virtual object and the second virtual object do not overlap, the display attribute setting unit 803 sets a display attribute of the first virtual object to “permitted”. Then, after the processing in step S1003, the processing of the information processing apparatus 102 proceeds to step S1004.

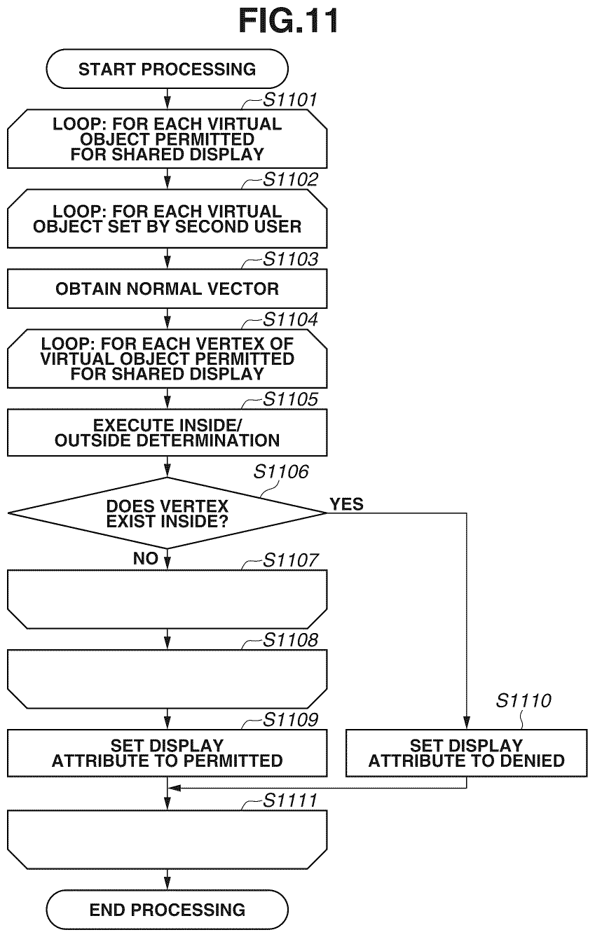

FIG. 11 is a flowchart illustrating details of the overlap determination processing performed by the overlap determination unit 802 in step S1002 of FIG. 10.

In step S1002, the overlap determination unit 802 executes processing in steps S1101 to S1111 of FIG. 11 on all first virtual objects permitted for shared display by the first user. More specifically, the processing in steps S1101 to S1111 is repeatedly executed for each first virtual object permitted for shared display.

The overlap determination unit 802 also executes processing in steps S1102 to S1108 of FIG. 11 on all second virtual objects set by the second user. More specifically, the processing in steps S1102 to S1108 is repeatedly executed for each second virtual object set by the second user.

The overlap determination unit 802 also executes processing in steps S1104 to S1107 of FIG. 11 on vertices of all the first virtual objects permitted for shared display by the first user. More specifically, the processing in steps S1104 to S1107 is repeatedly executed for each vertex of the first virtual objects permitted for shared display. In the repeated processing in steps S1102 to S1108, as the processing in step S1103, the overlap determination unit 802 calculates a centroid position and a normal vector for all surfaces of the second virtual object that is a target in the repeated processing. The normal vector is a vector that is vertical to a surface and is directed toward the inside of an virtual object.

Furthermore, the overlap determination unit 802 determines whether a vertex that is a target in the repeated processing in steps S1104 to S1107, among all vertices of the first virtual objects that are targets in the repeated processing in steps S1101 to S1111, exists inside the second virtual object.

Here, for inside/outside determination processing of determining whether a vertex of the first virtual object exists inside the second virtual object, for example, the following processing can be used. The overlap determination unit 802 calculates a vector connecting a centroid position and a processing target vertex of the first virtual object for each surface constituting the second virtual object. Then, the overlap determination unit 802 calculates an angle formed by the vector and the normal vector obtained in step S1103. For the calculation of the angle, for example, a method of calculating an inner product of the vectors can be used. In a case where the angle formed by the vectors is equal to or smaller than 90 degrees, the overlap determination unit 802 determines that the processing target vertex of the first virtual object exists on the inside relative to the surface of the second virtual object. The overlap determination unit 802 performs such processing on all the surfaces constituting the second virtual object. Then, in a case where it is determined that the processing target vertex of the first virtual object exists on the inside relative to all the surfaces constituting the second virtual object, the overlap determination unit 802 determines that the vertex exists inside the second virtual object.

Next, in step S1106, the overlap determination unit 802 branches the processing in accordance with a result of the inside/outside determination processing in step S1105. For example, in a case where it is determined in step S1105 that a vertex of the first virtual object exists inside the second virtual object, the processing of the overlap determination unit 802 proceeds to step S1110. On the other hand, in a case where it is determined in step S1105 that a vertex of the first virtual object does not exist inside the second virtual object, the overlap determination unit 802 performs the inside/outside determination processing in step S1105 on the next vertex of the first virtual object as the processing target. Then, in a case where all the processing target vertices of the first virtual object do not exist inside the second virtual object, the processing of the overlap determination unit 802 proceeds to step S1109.

In a case where the processing proceeds to step S1110, the overlap determination unit 802 sets the display, in the MR space of the second HMD 101, of the first virtual object that has a vertex determined to exist inside the second virtual object, to “denied”.

On the other hand, in a case where the processing proceeds to step S1109, the overlap determination unit 802 sets the display, in the MR space of the second HMD 101, of the first virtual object that has no vertices determined to exist inside the second virtual object, to “permitted”.

As described above, in a case where the first virtual object permitted for shared display by the first user overlaps the second virtual object, the information processing apparatus 102 according to the second exemplary embodiment can automatically set the first virtual object so as not to be displayed on the second HMD 101. More specifically, in the second exemplary embodiment, in a case where the first virtual object permitted for shared display by the first user overlaps the second virtual object, the second user does not have to perform a setting operation of a display attribute for preventing the first virtual object from being displayed on the second HMD 101.

As a situation where a second user does not want to display a first virtual object permitted for shared display by a first user, aside from the overlap described in the second exemplary embodiment, a case is assumed where a second virtual object is blocked by the first virtual object in a MR space of a second HMD 101. More specifically, a case where the second virtual object is blocked by the first virtual object in the MR space of the second HMD 101, and the second virtual object becomes invisible to the second user (viewing is hindered). In a third exemplary embodiment, blocking of a virtual object may include not only a case where the virtual object is completely blocked, but also a case where at least part of the virtual object is blocked.

In view of the foregoing, an information processing apparatus 102 according to the third exemplary embodiment performs a blocking determination of determining whether the second virtual object set by the second user is blocked by the first virtual object permitted for shared display by the first user. Then, the information processing apparatus 102 according to the third exemplary embodiment sets the display in the MR space of the second HMD 101 of the second user of the first virtual object permitted for shared display by the first user to “permitted” or “denied” based on a result of the blocking determination. In the third exemplary embodiment, the blocking by the first virtual object may include a case where only a part of the second virtual object is blocked, aside from a case where the second virtual object is completely blocked. In the third exemplary embodiment, the configuration of the HMD system is similar to that in the example illustrated in FIG. 1, and the configuration of the HMD 101 and the configuration of the information processing apparatus 102 are also similar to those in the examples illustrated in FIGS. 2 and 3, respectively. Thus, the illustration and description thereof will be omitted. Hereinafter, configurations and processing different from those in the first exemplary embodiment will be described.

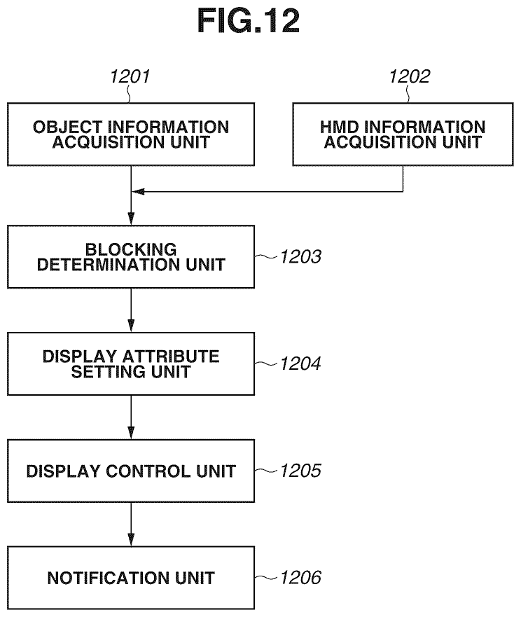

FIG. 12 is a diagram illustrating a functional configuration example of the information processing apparatus 102 according to the third exemplary embodiment.

In the functional configuration illustrated in FIG. 12, an object information acquisition unit 1201, a display control unit 1205, and a notification unit 1206 are substantially similar to the object information acquisition unit 401, the display control unit 403, and the notification unit 404, which are corresponding components in FIG. 4. Thus, the description thereof will be omitted.

In the information processing apparatus 102 according to the third exemplary embodiment, an HMD information acquisition unit 1202 acquires information such as the position and orientation in the MR space, a display field of view, and a display resolution of the second HMD 101, which is used by the second user. In the present exemplary embodiment, information such as a position and orientation in the MR space, a display field of view, and a display resolution of an HMD will be referred to as HMD information.

A blocking determination unit 1203 performs a blocking determination based on respective pieces of virtual object information of the first virtual object and the second virtual object that are acquired by the object information acquisition unit 1201, and the HMD information acquired by the HMD information acquisition unit 1202. Details of blocking determination processing performed by the blocking determination unit 1203 will be described below.

A display attribute setting unit 1204 sets a display attribute of permitting or denying the display of the first virtual object in the MR space of the second HMD 101, based on a blocking determination result obtained by the blocking determination unit 1203.

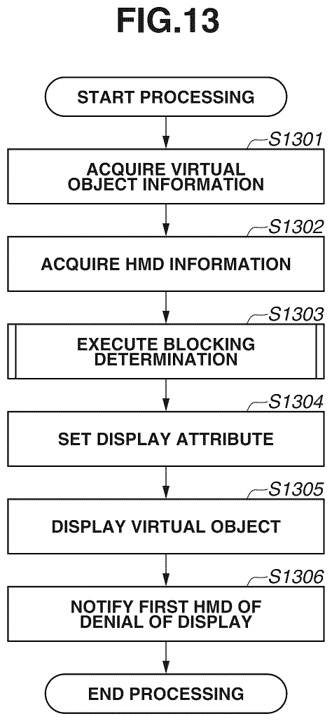

FIG. 13 is a flowchart illustrating a flow of information processing to be performed by each functional unit illustrated in FIG. 12, in the information processing apparatus 102 according to the third exemplary embodiment. In the flowchart in FIG. 13, because the processing in steps S1301, S1305, and S1306 is substantially similar to the processing in corresponding steps S501, S503, and S504 of FIG. 5, the description thereof will be omitted.

In the case of the third exemplary embodiment, after acquisition of virtual object information in step S1301, the processing of the information processing apparatus 102 proceeds to step S1302 in which processing is performed by the HMD information acquisition unit 1202. When the processing proceeds to step S1302, the HMD information acquisition unit 1202 acquires the HMD information including information such as a position and orientation in the MR space, a display field of view, and a display resolution of the second HMD 101.

Next, in step S1303, the blocking determination unit 1203 performs the blocking determination of determining whether the second virtual object is blocked by the first virtual object permitted for shared display by the first user in the MR space of the second HMD 101, which is used by the second user. Details of the blocking determination processing in step S1302 will be described below.

Next, in step S1304, the display attribute setting unit 803 sets a display attribute of permitting or denying the display of the first virtual object in the MR space of the second HMD 101 based on a result of the blocking determination obtained by the blocking determination unit 1203. More specifically, in a case where the second virtual object is blocked by the first virtual object, the display attribute setting unit 803 sets the display attribute of the first virtual object to “denied”. On the other hand, in a case where the second virtual object is not blocked by the first virtual object, the display attribute setting unit 803 sets the display attribute of the first virtual object to “permitted”. Then, after step S1304, the processing of the information processing apparatus 102 proceeds to step S1305.

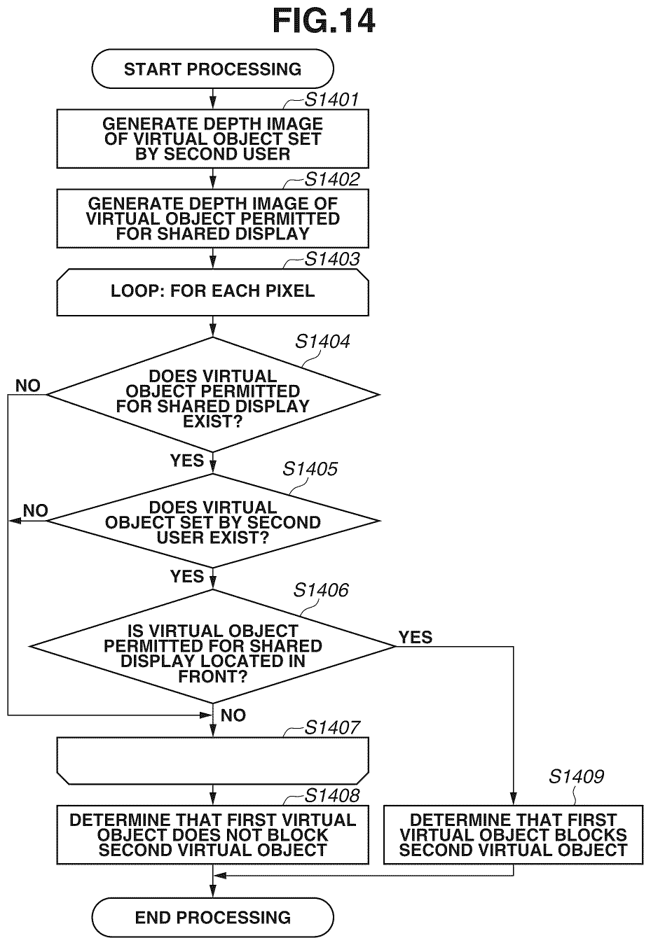

FIG. 14 is a flowchart illustrating details of the blocking determination processing performed by the blocking determination unit 1203 in step S1302 of FIG. 13.

First, as processing in step S1401, the blocking determination unit 1203 generates a depth image by projecting the second virtual object onto the MR space of the second HMD 101, which is used by the second user. The depth image is an image to be drawn in accordance with a distance in the MR space, and can be generated by execution of known rendering processing. The HMD information in step S1302 is used in converting coordinates included in the rendering processing.

Next, in step S1402, the blocking determination unit 1203 generates a depth image by projecting a first virtual object permitted for shared display by the first user onto the MR space of the second HMD 101.

The depth image in this case can also be generated by execution of known rendering processing similar to that in step S1401.

Next, the blocking determination unit 1203 executes processing in steps S1403 to S1407 of FIG. 14 on all pixels on a display screen of the second HMD 101, which is used by the second user. More specifically, the blocking determination unit 1203 repeats the processing in steps S1403 to S1407 for each pixel on the display screen of the second HMD 101.

In the repeated processing in steps S1403 to S1407, as processing in step S1404, the blocking determination unit 1203 branches the processing in accordance with whether the first virtual object permitted for shared display by the first user exists at a location of a pixel that is a target of the repeated processing. In a case where the blocking determination unit 1203 determines that the first virtual object permitted for shared display exists at a location of the processing target pixel (YES in step S1404), the blocking determination unit 1203 advances the processing to step S1405. On the other hand, in a case where the blocking determination unit 1203 determines that the first virtual object permitted for shared display does not exist at the location of the pixel that is the processing target (NO in step S1404), the next pixel becomes the target of the repeated processing. Here, the determination processing of determining whether the first virtual object permitted for shared display by the first user exists is performed based on the depth image generated from the first virtual object in step S1402. More specifically, in a case where the processing target pixel exists in the depth image generated from the first virtual object, and the pixel value of the processing target pixel is not the value of the far plane, the blocking determination unit 1203 determines that the first virtual object exists at the location of the processing target pixel.

In a case where the processing proceeds to step S1405, the blocking determination unit 1203 branches the processing in accordance with whether the second virtual object set by the second user exists at the location of the processing target pixel. In a case where the second virtual object exists at the location of the processing target pixel (YES in step S1405), the processing proceeds to step S1406. In a case where the second virtual object does not exist at the location of the processing target pixel (NO in step S1405), the processing proceeds to step S1407. In a case where the blocking determination unit 1203 determines that the second virtual object exists at the location of the processing target pixel (YES in step S1405), the processing proceeds to step S1406. On the other hand, in a case where the blocking determination unit 1203 determines that the second virtual object does not exist at the location of the processing target pixel (NO in step S1405), the next pixel becomes the target of the repeated processing. The determination processing of determining whether the second virtual object exists is performed based on the depth image generated from the second virtual object in step S1401. In a case where the processing target pixel exists in the depth image generated from the second virtual object, and the pixel value of the processing target pixel is not the value of the far plane, which indicates a far distance invisible in the MR space, the blocking determination unit 1203 determines that the second virtual object exists at the location of the processing target pixel.

In a case where the processing proceeds to step S1406, the blocking determination unit 1203 compares the depth value at the location of the processing target pixel in the depth image generated from the first virtual object and the depth value at a corresponding pixel location in the depth image generated from the second virtual object. Then, based on a comparison result of the depth values at the corresponding pixel locations, the blocking determination unit 1203 determines which of the virtual objects is located in front in the MR space of the second HMD 101, and in a case where the blocking determination unit 1203 determines that the first virtual object is located in front (YES in step S1406), the blocking determination unit 1203 advances the processing to step S1409. On the other hand, in a case where the blocking determination unit 1203 determines that the second virtual object is located in front (NO in step S1406), the blocking determination unit 1203 sets the next pixel as a target of the repeated processing.

Then, in a case where the processing proceeds to step S1409, the blocking determination unit 1203 determines that the first virtual object blocks the second virtual object in the MR space of the second HMD 101, which is used by the second user.

On the other hand, as a result of executing the repeated processing in steps S1403 to S1407 on all of the pixels on the display screen of the second HMD 101, in a case where it is determined in step S1406 that the second virtual object is located in front (NO in step S1406), the processing of the blocking determination unit 1203 proceeds to step S1408.

In a case where the processing proceeds to step S1408, the blocking determination unit 1203 determines that the first virtual object does not block the second virtual object in the MR space of the second HMD, which is used by the second user.

As described above, in a case where the second virtual object is blocked by the first virtual object permitted for shared display by the first user, the information processing apparatus 102 according to the third exemplary embodiment can automatically set the first virtual object to be not displayed on the second HMD 101. In other words, in the third exemplary embodiment, in a case where the second virtual object is blocked by the first virtual object permitted for shared display by the first user, the second user may omit a setting operation of a display attribute for preventing the first virtual object from being displayed on the second HMD 101.

In the above-described first to third exemplary embodiments, an example of manually or automatically controlling whether to display the first virtual object permitted for shared display by the first user in the MR space of the second HMD 101, which is used by the second user, has been described. In a case where control is performed not to display the first virtual object permitted for shared display by the first user in this manner, as a matter of course, the second user cannot identify where the first virtual object is arranged in the MR space of the second HMD 101. Thus, the second user can place a real object, which is not a virtual object, at the position of the first virtual object permitted for shared display by the first user in the MR space. In this case, the view of the first virtual object is disturbed by the real object in the MR space being experienced by the first user using the first HMD 101.

In view of the foregoing, in a fourth exemplary embodiment, an example of presenting, to the second HMD 101 of the second user, a region in which the first user views a first virtual object using the first HMD 101 in a case where the display attribute of the first virtual object permitted for shared display by the first user is set to a non-display state will be described.

In the present exemplary embodiment, the region in which the first user views the first virtual object using the first HMD 101 will be referred to as a viewing region. An information processing apparatus 102 according to the fourth exemplary embodiment sets the viewing region based on the position and orientation of the first HMD 101 in the MR space and the position of the first virtual object in the MR space. In the fourth exemplary embodiment, the configuration of the HMD system is similar to that in the example illustrated in FIG. 1, and the configuration of the HMD 101 and the configuration of the information processing apparatus 102 are also similar to those in the examples illustrated in FIGS. 2 and 3, respectively. Thus, the illustration and description thereof will be omitted. Hereinafter, configurations and processing different from those in the above-described exemplary embodiments will be described.

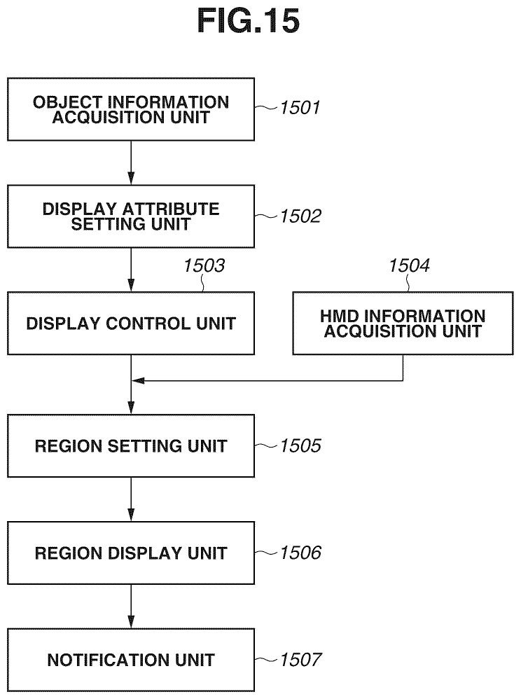

FIG. 15 is a diagram illustrating a functional configuration example of the information processing apparatus 102 according to the fourth exemplary embodiment.

An object information acquisition unit 1501, a display attribute setting unit 1502, a display control unit 1503, and a notification unit 1507 are substantially similar to the object information acquisition unit 401, the display attribute setting unit 402, the display control unit 403, and the notification unit 404, which are corresponding components in FIG. 4. Thus, the description thereof will be omitted.

In the information processing apparatus 102 according to the fourth exemplary embodiment, an HMD information acquisition unit 1504 acquires information such as the position and orientation in the MR space, a display field of view, and a display resolution of the first HMD 101 used by the first user who has permitted shared display of the first virtual object. As in the example of the above-described third exemplary embodiment, information such as the position and orientation in the MR space, a display field of view, and a display resolution of an HMD 101 will be referred to as HMD information also in the fourth exemplary embodiment. Nevertheless, while the HMD information described in the third exemplary embodiment is information regarding the second HMD 101, which is used by the second user, the HMD information in the case of the fourth exemplary embodiment is information regarding the first HMD 101 used by the first user.

A region setting unit 1505 sets the viewing region based on virtual object information of the first virtual object permitted for shared display by the first user, a display attribute set for the first virtual object, and the HMD information acquired by the HMD information acquisition unit 1504. In a case where a display attribute of a first virtual object permitted for shared display is set to “denied”, the region setting unit 1505 sets a region between the first HMD 101 and the first virtual object in the MR space as the viewing region. Details of viewing region setting processing to be performed by the region setting unit 1505 will be described below. The denial setting of the display attribute of the first virtual object permitted for shared display may be performed by the second user as in the above-described first exemplary embodiment, or may be automatically performed by the information processing apparatus 102 as in the second to fourth exemplary embodiments.

A region display unit 1506 presents (displays) the viewing region set by the region setting unit 1505 in the MR space of the second HMD 101, which is used by the second user. More specifically, the region display unit 1506 presents, in the MR space of the second HMD 101, the viewing region in which the first user is viewing the first virtual object in the MR space of the first HMD 101.

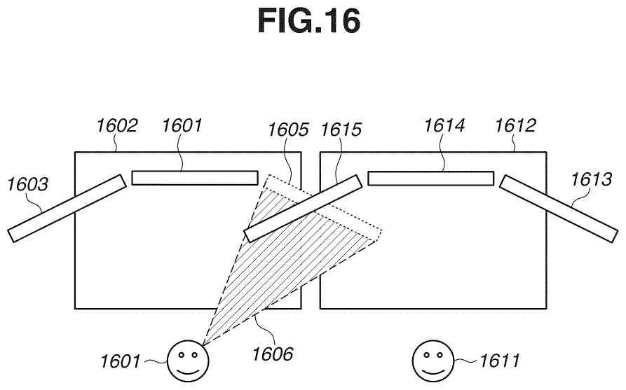

FIG. 16 is a schematic diagram illustrating an overhead view of an MR space being experienced by a first user 1601 using a first HMD (not illustrated), or being experienced by a second user 1611 using a second HMD (not illustrated). FIG. 16 illustrates an example in which desks 1602 and 1612 that are real objects exist in the MR space, and a plurality of virtual monitors 1603, 1604, 1605, 1613, 1614, and 1615 are arranged as virtual objects. Among these virtual monitors, the virtual monitors 1603, 1604, and 1605 are virtual objects set by the first user 1601, whereas the virtual monitors 1613, 1614, and 1615 are virtual objects set by the second user 1611. In addition, shared display of the virtual monitors 1603, 1604, and 1605 is permitted by the first user 1601.

Here, because the virtual monitor 1605 obstructs the second user 1611 from viewing the virtual monitor 1615, a display attribute of the virtual monitor 1605 permitted for shared display by the first user 1601 is set to a non-display state. In this case, the region setting unit 1505 sets a viewing region 1606 of the first user 1601 based on a positional relationship between the positions of the HMD of the first user 1601 and the virtual monitor 1605, and the position of the HMD of the second user 1611. In the example in FIG. 6, for the sake of convenience of illustration, the viewing region 1606 is illustrated as a two-dimensional region not having a height. Nevertheless, since the MR space is a three-dimensional space, the viewing region 1606 is actually calculated as a three-dimensional region having a height.

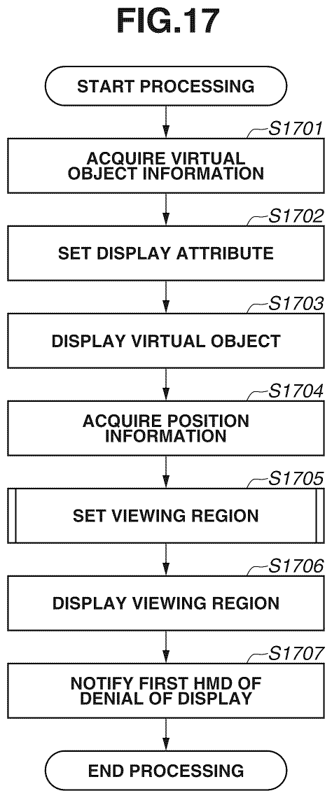

FIG. 17 is a flowchart illustrating a flow of information processing to be performed by each functional unit illustrated in FIG. 15, in the information processing apparatus 102 according to the fourth exemplary embodiment. In the flowchart in FIG. 17, because the processing in steps S1701, S1702, S1703, and S1707 is substantially similar to the processing in corresponding steps S501, S502, S503, and S504 of FIG. 5, the description thereof will be omitted.

In the case of the fourth exemplary embodiment, after step S1703, the processing of the information processing apparatus 102 proceeds to step S1704 in which processing is performed by the HMD information acquisition unit 1504.

When the processing proceeds to step S1704, the HMD information acquisition unit 1504 acquires HMD information such as the position and orientation in the MR space, a display field of view, and a display resolution of the first HMD, which is used by the first user who has permitted shared display of the first virtual object.

Next, in step S1705, the region setting unit 1505 sets the viewing region based on the position of the first virtual object permitted for shared display, the display attribute set for the first virtual object, and the HMD information acquired by the HMD information acquisition unit 1504. Details of the viewing region setting processing in step S1705 will be described below.

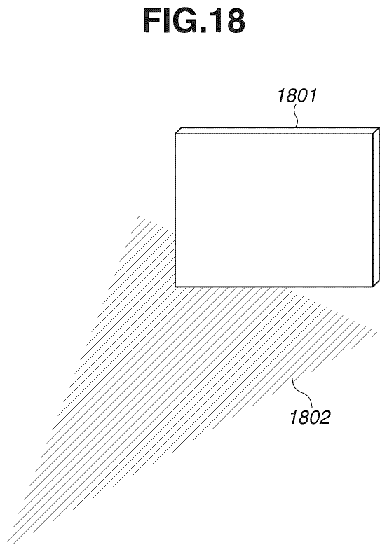

Next, in step S1706, the region display unit 1506 presents the viewing region set in step S1705 in the MR space of the second HMD 101, which is used by the second user. As the presentation of the viewing region to the second HMD 101, for example, presentation of displaying the viewing region by filling the inside of the viewing region with a translucent color is considered. In addition, in a case where a second virtual object exists inside the viewing region, the viewing region may be displayed so as not to obstruct viewing of the second virtual object. For example, an example is considered where a virtual plane is defined at the height of a vertex with the lowest height among vertices constituting the second virtual object existing inside the viewing region, and displaying an overlap region of the virtual plane and the viewing region by filling the overlap region with a predetermined pattern having a transparent background color. FIG. 18 is a diagram illustrating an example of displaying an overlap region of a virtual plane and a viewing region by filling the overlap region with a predetermined pattern having a transparent background color. As illustrated in FIG. 18, in a case where a second virtual object 1801 exists inside a viewing region 1802, the region display unit 1506 displays the viewing region 1802 at the height of a vertex with the lowest height among vertices constituting the second virtual object 1801. As a matter of course, the method for presenting (displaying) a viewing region is not limited to these examples. After step S1706, the processing of the information processing apparatus 102 proceeds to step S1707, which is similar to step S504.

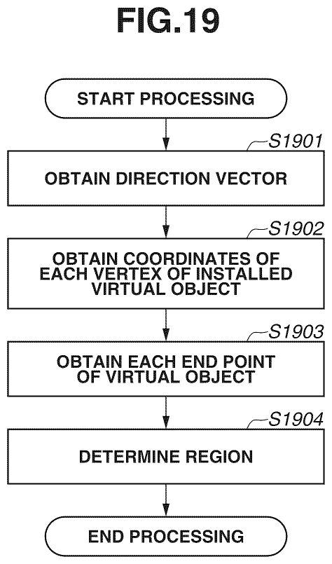

FIG. 19 is a flowchart illustrating viewing region setting processing performed by the region setting unit 1505 in step S1705 of FIG. 7.

First, as processing in step S1901, the region setting unit 1505 calculates a direction vector connecting the position of the first HMD 101 acquired in step S1704 and the position of the first virtual object acquired in step S1701.

Next, as processing in step S1902, the region setting unit 1505 calculates coordinates of each vertex of the first virtual object when the first virtual object is installed in the MR space based on the virtual object information acquired in step S1701.

Next, as processing in step S1903, the region setting unit 1505 obtains each vertex serving as an end point of the first virtual object using the direction vector calculated in step S1901 and the coordinates of each vertex calculated in step S1902. Each vertex that serves as an end point of the first virtual object can be obtained as follows, for example. First, the region setting unit 1505 obtains a positional relationship between any vertex of interest and the direction vector. For example, the region setting unit 1505 obtains a cross product between a vector connecting the vertex of interest and the position of the first HMD 101, and the direction vector, obtains on which of the left and right sides of the direction vector the vertex exists based on the sigh of the cross product, and calculates a distance between the direction vector and the vertex of interest. The region setting unit 1505 performs the above processing on all vertices, and calculates a vertex having the greatest distance for each of the left and right sides of the direction vector. The vertex serves as an end point of the first virtual object.

Next, as processing in step S1904, the region setting unit 1505 sets, as the viewing region, a triangular prism-shaped region obtained by extending a region surrounded by a line connecting the end point obtained in step S1903 and the position of the first HMD 101 acquired in step S1704, in the height direction of the first virtual object in the MR space.

As described above, the information processing apparatus 102 according to the fourth exemplary embodiment sets a region between the first user and the first virtual object permitted for shared display by the first user as a viewing region, and displays the viewing region in the MR space of the second HMD 101, which is used by the second user. With this configuration, even in a case where the display attribute of the first virtual object is set to “denied”, the second user can grasp the viewing region when the first user views the first virtual object, and can recognize that it is undesirable to place a real object, for example, in the viewing region.

### First Modified Example

In the above-described exemplary embodiments, in a case where the display attribute of the first virtual object permitted for shared display is set to “denies”, the first virtual object is prevented from being displayed in the MR space of the second HMD 101. In contrast, as a first modified example, the first virtual object may be displayed using another drawing method so as not to obstruct viewing by the second user. For example, a drawing method of lowering a degree of transparency of the first virtual object may be used, or a drawing method of drawing only the shape of the object using a wireframe may be used.

### Second Modified Example

In the above-described second exemplary embodiment, the overlap between the first virtual object permitted for shared display and the second virtual object set by the second user is determined, but the overlap determination is not limited to this example. In the case of a second modified example, a region where the second virtual object can be arranged is preset as a non-display region, and the overlap determination unit 802 determines whether at least a part of the first virtual object overlaps (contacts or interferes with) the non-display region.

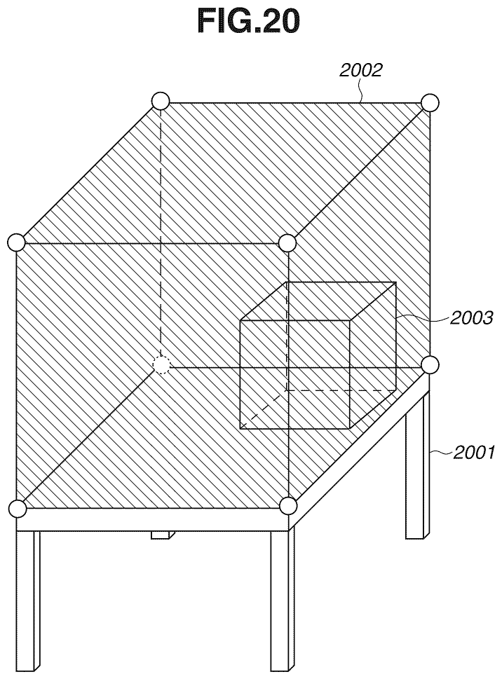

FIG. 20 is a diagram to be used for the description of the second modified example. In the example in FIG. 20, a region in the shape of a rectangular cuboid having eight vertices, for example, is preset as a non-display region 2002 on a table 2001 being a real object existing in the MR space. Then, the overlap determination unit 802 of the second modified example performs overlap determination of the preset non-display region 2002 and a first virtual object 2003 permitted for shared display by the first user. In the case of the example in FIG. 20, because the first virtual object 2003 and the preset non-display region 2002 overlap, the display attribute setting unit 803 sets the display attribute of the first virtual object 2003 to “denied”.

The above-described exemplary embodiments and the modified examples may be appropriately combined. For example, in a case where the first exemplary embodiment and the second exemplary embodiment or the third exemplary embodiment are combined, for example, together with the setting of the display attribute that is made by the second user, the setting of the display attribute may be made by the information processing apparatus 102. For example, in a case where the second exemplary embodiment and the third exemplary embodiment are combined, it is possible to set the display attribute of a virtual object based on determination results of both the overlap determination and the blocking determination of virtual objects. Furthermore, the fourth exemplary embodiment, the first modified example, or the second modified example can be applied to the first to third exemplary embodiments.

The present disclosure can also be realized by processing of supplying a program that implements one or more functions of the above-described exemplary embodiments to a system or an apparatus via a network or a storage medium, and reading and executing the program by one or more processors in a computer of the system or the apparatus. The present disclosure can also be realized by a circuit (for example, an application specific integrated circuit (ASIC)) that implements one or more functions.

The above-described exemplary embodiments are merely specific examples for carrying out the present disclosure, and the technical scope of the present disclosure is not to be construed in a limited manner based on these exemplary embodiments.

In other words, the present disclosure can be executed in various forms without departing from the technical idea thereof or major features thereof.

According to the exemplary embodiments of the present disclosure, it is possible to reduce the time and effort of the user.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-112560, filed Jul. 12, 2024, which is hereby incorporated by reference herein in its entirety.

What is claimed is:

1. An information processing apparatus comprising:
one or more memories storing instructions; and
one or more processors executing the instructions to function as:
an attribute setting unit configured to set, for a first virtual object permitted for shared display by a first user in a space where virtual objects are arranged, a display attribute indicating permission or denial of display in the space which is experienced by a second user based on an instruction issued by the second user; and
a display control unit configured to control display of the first virtual object in the space experienced by the second user based on the display attribute set for the first virtual object.

2. The information processing apparatus according to claim 1, wherein execution of the instructions further causes the one or more processors to perform control, in a case where the display attribute set for the first virtual object indicates the denial, not to display the first virtual object in the space experienced by the second user.

3. The information processing apparatus according to claim 1, wherein execution of the instructions causes the one or more processors to display the first virtual object in the space experienced by the second user by changing a drawing method of the first virtual object when the display attribute set for the first virtual object indicates the denial.

4. The information processing apparatus according to claim 3, wherein the drawing method of the first virtual object used when the display attribute indicates the denial includes a drawing method that lowers a degree of transparency of the first virtual object.

5. The information processing apparatus according to claim 3, wherein the drawing method of the first virtual object used when the display attribute indicates the denial includes a drawing method that draws the first virtual object as a wireframe.

6. The information processing apparatus according to claim 1, wherein execution of the instructions further causes the one or more processors to set the display attribute based on an instruction from the second user.

7. The information processing apparatus according to claim 1,
wherein execution of the instructions further causes the one or more processors to function as an overlap determination unit configured to determine overlap between the first virtual object and a second virtual object set by the second user, and
wherein, when the overlap determination unit determines that the first virtual object and the second virtual object overlap at least partially, the attribute setting unit sets, for the first virtual object, the display attribute indicating denial of display in the space experienced by the second user.

8. The information processing apparatus according to claim 7, wherein execution of the instructions causes the one or more processors to function as the overlap determination unit configured to determine that the first virtual object and the second virtual object overlap when at least a part of the first virtual object is contained inside the second virtual object.

9. The information processing apparatus according to claim 8, wherein execution of the instructions causes the one or more processors to function as the overlap determination unit configured to, for all surfaces of the second virtual object,
acquire a centroid and a normal vector for each surface of the second virtual object;
calculate an angle formed by a vector connecting the centroid of the surface of the second virtual object and a vertex of the first virtual object and the normal vector; and
in a case where the calculated angle is equal to or smaller than 90 degrees for all the surfaces of the second virtual object, determine that the first virtual object and the second virtual object overlap.

10. The information processing apparatus according to claim 1,
wherein execution of the instructions further causes the one or more processors to function as an overlap determination unit configured to determine overlap between a non-display region set in the space experienced by the second user and the first virtual object, and
wherein, when the overlap determination unit determines that the non-display region and the first virtual object overlap at least partially, the attribute setting unit sets, for the first virtual object, the display attribute indicating denial of display in the space experienced by the second user.

11. The information processing apparatus according to claim 1,
wherein execution of the instructions further causes the one or more processors to function as a blocking determination unit configured to determine whether a second virtual object set by the second user is blocked by the first virtual object, and
wherein, when the blocking determination unit determines that at least a part of the second virtual object is blocked by the first virtual object, the attribute setting unit sets, for the first virtual object, the display attribute indicating denial of display in the space experienced by the second user.

12. The information processing apparatus according to claim 11, wherein execution of the instructions further causes the one or more processors to function as the blocking determination unit configured to determine whether the second virtual object is blocked by the first virtual object based on distances from the second user to the second virtual object and the first virtual object in the space experienced by the second user.

13. The information processing apparatus according to claim 12, wherein execution of the instructions further causes the one or more processors to function as the blocking determination unit configured to determine whether the second virtual object is blocked by the first virtual object in the space experienced by the second user based on a comparison result of depth values, for each pixel, at corresponding positions in a depth image generated by projecting the second virtual object and a depth image generated by projecting the first virtual object.

14. The information processing apparatus according to claim 1, wherein execution of the instructions further causes the one or more processors to function as:
a region setting unit configured to set a viewing region in which the first user views the first virtual object in the space experienced by the first user; and
a region display unit configured to display the viewing region in the space experienced by the second user.

15. The information processing apparatus according to claim 14, wherein execution of the instructions further causes the one or more processors to set, as the viewing region, a region obtained by extending a region surrounded by a line connecting a position of the first user in the space experienced by the first user, and each vertex serving as an end point of the first virtual object in a height direction of the first virtual object in the space.

16. The information processing apparatus according to claim 15, wherein execution of the instructions further causes the one or more processors to:
obtain a direction in which each vertex of the first virtual object exists with respect to a direction vector, based on a cross product of a direction vector connecting a position of the first user and the first virtual object in the space experienced by the first user, and a vector connecting each vertex of the first virtual object and the position of the first user;
calculate a distance of the first virtual object with respect to the direction vector for each direction in which each vertex of the first virtual object exists; and
set a vertex with the greatest distance as an end point of the first virtual object.

17. The information processing apparatus according to claim 1, wherein the display control unit further includes a notification unit configured to notify the first user that the display attribute indicates the denial when the set display attribute of the first virtual object indicates the denial.

18. The information processing apparatus according to claim 1, wherein the space experienced by the user is a mixed reality space, and the user experiences the mixed reality space using a head-mounted display device.

19. An information processing method comprising:
setting, for a first virtual object permitted for shared display by a first user in a space where virtual objects are arranged, a display attribute indicating permission or denial of display in the space which is experienced by a second user based on an instruction issued by the second user; and
controlling display of the first virtual object in the space experienced by the second user based on the display attribute set for the first virtual object.

20. A non-transitory computer-readable storage medium storing instructions that, when executed by a computer, cause the computer to:
set, for a first virtual object permitted for shared display by a first user in a space where virtual objects are arranged, a display attribute indicating permission or denial of display in the space which is experienced by a second user based on an instruction issued by the second user; and
control display of the first virtual object in the space experienced by the second user based on the display attribute set for the first virtual object.
